(19) United States
(12) Patent Application Publication
(10) Pub. No.: US 2026/0203698 A1
(43) Pub. Date: Jul. 16, 2026

(54) CONTRIBUTION AWARE 3D MODELING

(71) Applicant: INTERNATIONAL BUSINESS MACHINES CORPORATION, Armonk, NY (US)

(72) Inventors: Jessica Nahulan, Vaughan (CA); Carolina Garcia Delgado, Zapopan (MX); Jeremy R. Fox, Georgetown, TX (US); Tiberiu Suto, Franklin, NY (US)

(21) Appl. No.: 19/020,353

(22) Filed: Jan. 14, 2025

(51) Int. Cl. G06Q 10/0639; G06Q 30/0282; G06Q 50/00

(52) U.S. Cl. CPC G06Q 10/06395; G06Q 10/40; G06Q 30/0282

(57) ABSTRACT

A computer-implemented method includes tracking, by a tracking component, design contributions and design developments for a three-dimensional (3D) model and associating, by the tracking component, the design contributions with individual designers. Social interest feedback related to a product manufactured based on the 3D model is analyzed, by an apportionment component. The apportionment component determines, by using natural language processing and machine learning, features of the product that contributed to the social interest. A credit distribution system apportions credit to the individual designers based on their design contributions associated with the determined features.

### BACKGROUND

The present invention generally relates to three-dimensional (3D) modeling and more particularly to 3D modeling that tracks contributions from individual modelers.

3D modelling is a process of creating a three-dimensional representation of an object or a scene using computer software. 3D modeling has many applications in various fields, such as entertainment, engineering, architecture, medicine, education, etc. However, 3D modeling is also a complex and time-consuming task that requires a high level of skill and creativity. 3D modelers often are assigned to work on various sections of a model and often one section or piece of the model can be the key feature which led to the overall success of the entire product.

### SUMMARY

In accordance with an embodiment of the present invention, a computer-implemented method includes tracking, by a tracking component, design contributions and design developments for a three-dimensional (3D) model and associating, by the tracking component, the design contributions with individual designers. Social interest feedback related to a product manufactured based on the 3D model is analyzed, by an apportionment component. The apportionment component determines, by using natural language processing and machine learning, features of the product that contributed to the social interest. A credit distribution system apportions credit to the individual designers based on their design contributions associated with the determined features.

In accordance with another embodiment of the present invention, a computer system includes a processor set, one or more computer-readable storage media and program instructions stored on the one or more computer-readable storage media to cause the processor set to perform operations. The operations include tracking design contributions and design developments for a three-dimensional (3D) model; associating the design contributions with individual designers; analyzing social interest feedback related to a product manufactured based on the 3D model; determining, using natural language processing and machine learning, features of the product that contributed to the social interest; and apportioning credit to the individual designers based on their design contributions associated with the determined features.

In accordance with another embodiment of the present invention, a computer program product includes one or more computer-readable storage media and program instructions stored on the one or more computer-readable storage media to perform operations. The operations include tracking design contributions and design developments for a 3D model; associating the design contributions with individual designers; analyzing social interest feedback related to a product manufactured based on the 3D model; determining, using natural language processing and machine learning, features of the product that contributed to the social interest; and apportioning credit to the individual designers based on their design contributions associated with the determined features.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block diagram of a contribution aware system for apportioning credit between contributors, in accordance with an embodiment of the present invention;

FIG. 2 is a perspective view of a set of eyeglasses showing different portions as 3D printed components, in accordance with an embodiment of the present invention;

FIG. 3 is a perspective view of the set of eyeglasses showing different portions of the 3D printed components apportioned for credit for three contributors, in accordance with an embodiment of the present invention;

FIG. 4 is a block diagram showing a computer environment for a contribution aware system, in accordance with an embodiment of the present invention; and

FIG. 5 is a flow diagram showing contribution aware methods for 3D models, in accordance with an embodiment of the present invention.

### DETAILED DESCRIPTION

In accordance with embodiments of the present invention, contribution aware systems and methods are described which can track individual designer contributions to a model or an overall design. In an embodiment, a tracking component tracks design contributions and design developments for a 3D model. The tracking component includes contributions of individual designers. A Natural Language Processing (NLP) system with a Machine Learning (ML) algorithm can associate contributions by developers and contributors with social interest. The social interest can be determined based on private or public commentary, likes or other criteria. The social interest associated with a particular portion of a design can then be recognized and, in some instances, appropriate compensation can be determined based on individual contributors'impact of their work on a product's success.

An image and marketing analysis system can be employed to leverage techniques, such as, e.g., image recognition and data analytics to identify design elements that contributed to a product's success. An apportionment or credit distribution system can be employed to handle currency conversion and royalty issues to apportion fair compensation pertaining to individual contributors with authorship claims. The apportionment system yields fair compensation for true contributors of items within the 3D model and 3D printing process.

The image and marketing analysis system can discover and parse review comments related to a product using NLP. The image and marketing analysis system can determine variances in feature characteristics of the product that had a bearing in purchasing decisions and map this information back to the contribution aware system. The contribution aware system and methods thereof can incentivize and compensate 3D model designers based on the quality and impact of their work in a product's earnings based on factors such as their social network structure and dynamics, and market analytics.

The contribution aware system ensures contributors are adequately rewarded for their contributions to a 3D model design and development that closely corresponds with product value. To compensate 3D modeling developers, designers, and contributors, the contribution aware system considers social media feedback, product specifications, and the value of each contribution. The contribution aware system can analyze feedback using NLP to help identify which developers deserve compensation based on their contributions to successful product features. Additionally, image and marketing analysis can provide insight into which design aspects contribute to the product's success. In this way, each contributor can be associated with their work product and can receive a share of royalties in accordance with value-added to the product. An additional benefit can include incentivizing contributions and efforts towards future projects.

The contribution aware system can be employed to apportion compensation for freelancers, agencies, designers, etc. involved in 3D modeling projects. The compensation split depends on the value of the product and the contributions made by each contributor. The contribution aware system involves analyzing social interest, e.g., social media feedback, and reviewing comments using NLP or other tools to identify which contributors'contributions provide value to successful product features. Product specifications can also be considered in a same way to ensure each user is compensated for their contribution. Image and marketing analysis can be used to identify which design aspects contribute to the product's success. For example, in the case of a pencil, comments about its comfort and writing ability could lead to rewarding the team/person who worked on that part of the 3D model, as well as those involved in the design using computer aided design (CAD) software. By implementing the contribution aware system, freelancers, agencies and others will have their contributions recognized, and, in accordance therewith, compensation schedules can be derived to share in royalties for their contributions.

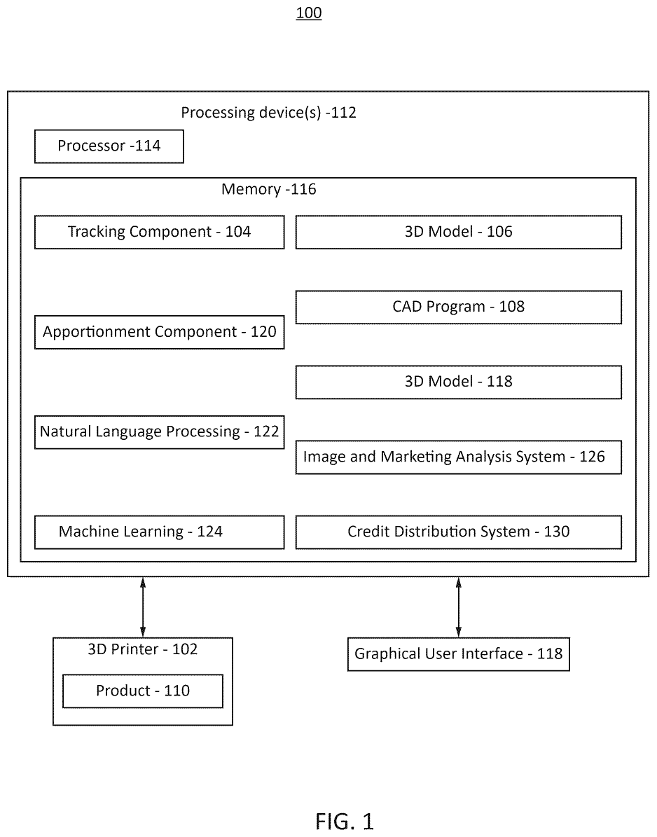

Referring now to the drawings in which like-numerals represent the same or similar elements and initially to FIG. 1, a contribution aware system 100 for tracking designer contributions for three dimensional (3D) models and 3D printed objects is shown and described in accordance with embodiments of the present invention. A printer 102 includes an additive manufacturing printer, such as, e.g., a 3D or four-dimensional (4D) printer. The contribution aware system 100 includes a tracking component 104 that tracks design processes and development processes for a 3D model 106. Design and development processes can include multiple users designing a single product. The product can be represented as the 3D model 106. The multiple users or contributors may have a contribution to a single element, to an assembly or any portions or portions of the 3D model 106. The tracking component 104 provides an index, a tag, a stamp or other indicators that represent which contributor designed or modified a portion of the 3D model 106 during a design phase of a project for designing a product 110 to be 3D printed. This association and tracking can be made initially by associating a design log in with designed parts or portions thereof. Each part or portion thereof will include this information so that the designer or contributor is known and can be associated with the feature or part.

In an embodiment, a first designer can employ a computer aided design (CAD) program 108 to design the product 110. The first designer can design a first portion of the product 110 that will be designated by the CAD program 108 with the name of the first designer and the portions created by the first designer. A second designer can design a second portion of the product 110 that will be designated by the CAD program 108 with the name of the second designer and the portions created by the second designer. The contributions of individual designers will be associated with different portions of the product 110 within the 3D model 106.

The contribution aware system 100 includes one or more processing devices 112. The processing devices 112 can include a computer, a cell phone or any other suitable processing devices that can run software and store data. The processing devices 112 can each include one or more processors 114 configured to control operations of the contribution aware system 100 and to run software stored in a memory 116. The memory 116 can include any form of memory including but not limited to a hard drive with solid state memory.

The memory 116 stores program code that runs features in accordance with embodiments of the present invention. The memory 116 also stores data including one or more computer designs including the 3D model 106 to be apportioned in accordance with design contribution and to be 3D printed as the product 110.

The contribution aware system 100 can be employed to design the product 110 using CAD tools, such as CAD program 108 that can create the one or more designs and portions of designs with contributions of the designers associated with the portions of the design. The design can be viewed by a user on a 3D model viewer on a graphical user interface (GUI) 118 of the contribution aware system 100. The design can be formulated on a different computer or a set of computers.

The contribution aware system 100 can include an apportionment component 120 that can analyze the 3D model 106 to determine an apportionment for each contributor. The apportionment component 120 can map the respective contributions of each contributor so that the individual contributors can be tracked and associated with the contributors to later assign a value to their contributions.

The 3D model 106 is printed or fabricated. In an embodiment, the 3D model 106 can be 3D printed. The product 110 can be sold or otherwise distributed to receive social interest and feedback.

Social interest can be determined by collecting data, e.g., from product reviews, news articles, product sales data and any other source. In an embodiment, the apportionment component 120 can include Natural Language Processing (NLP) 122 that can include a Machine Learning (ML) algorithm 124 that can identify which portions of the product 110 were of greatest interest or importance to purchasers or users. In one example, the product 110 can be rated on its utility, in another example, the product 110 can be rated on its appearance, in other examples the product can be reviewed or rated on portability, etc. Each of these and other factors can be apportioned to the contributions of the developers and contributors as impacting the design of the product 110. The apportionment component 120 can associate the feedback with portions of the design of the product 110. Exact measurements and details can be made attributable to each contributor, and/or an apportionment of an overall design (e.g., percentages) can be provided to the design of the product 110 as a whole. The apportionment component 120 can employ the NLP 122 and the ML algorithm 124 to determine features of the product 110 that led to the most social interest. Social interest can include positive product reviews, reporting of the product and other feedback sources. The social interest can be collected manually and input to the NLP 122 or can be automatically searched on-line and provided to the NLP 122.

An image and marketing analysis system 126 can be employed to measure social interest by leveraging techniques such as image recognition and data analytics to collect feedback to identify design elements or features that contributed to a product's success. The image and marketing analysis system 126 can search for images of the product 110 on the internet. Once the images are discovered, the image and marketing analysis system 126 can review the context of text, a page or website to determine if particular features are praised or critiqued. In this way, a scoring or ranking of the features of the product 110 can be obtained. The ranking or scoring can depend on utility, performance, appearance or any other factor that can be employed to measure the success of the product 110. The social interest can be fed back as input to the apportionment component 120 and specifically to the NLP 122 which, with the ML algorithm 124, can associate the features of the product 110 with the contributor's contributions. In an embodiment, user review comments of the product 110 can be parsed using NLP 122. The NLP 122 can determine a variance in feature characteristics of the product 110 that had a bearing on a purchasing decision, performance accolades, etc. This social interest can be mapped back to assist in apportionment decision making.

A credit distribution system 130 can associate values with features of the product 110 based upon the analysis of the apportionment component 120 and any agreements or industry standards. For example, a compensation formula can be employed to determine renumeration based upon how much a particular contributor contributed to a design of the product 110. In an embodiment, the credit distribution system 130 can handle currency conversions and royalty issues to enable compensation pertaining to authorship claims of the design of the product 110. The credit distribution system 130 can be employed to apportion credit for the greatest contributions to a product 110 and its success. In an embodiment, the credit distribution system 130 can be employed to apportion monetary compensation to the contributors for true makers of items within the 3D model 106 and 3D printing process.

The contribution aware system 100 combines components to function as a cohesive unit. This includes ensuring that data flows seamlessly between different parts of the contribution aware system 100 and that the outputs from one part (e.g., the NLP 122 or image analysis) can be used effectively by others (e.g., the credit distribution system 130).

To ensure fair compensation and incentivize teams for better product quality and contributions, the contribution aware system 100 can be employed to consider the value of a final product, contributions made by each user, and social media feedback along with market analysis and performance. The contribution aware system 100 can use natural language processing to analyze feedback and identify significant contributions that led to product success. NLP algorithms extract information from user comments and analysis reports to identify specific features that resonate with customers, such as comfort, quality, popularity, and ease of use and then reward contributors to these high performing product features.

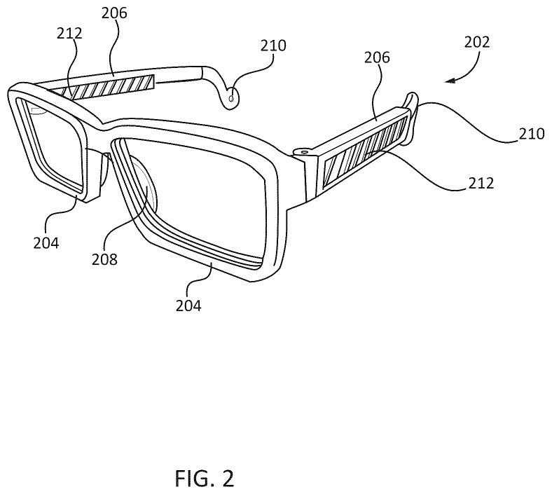

Referring to FIG. 2 with continued reference to FIG. 1, eyeglasses 202 can be employed as an example to describe embodiments in accordance with the present invention. Components of the eyeglasses 202 can include frames 204, arms or temples 206, nose pads 208, end portions 210 and other components. Each component can also include design elements, e.g., pattern 212, which can include textures, shapes and other design elements. The components of the eyeglasses 202 can be 3D printed from the 3D model 106. The 3D model 106 can be created by multiple users and each user's contribution can be tracked.

After printing, the components can be assembled to complete manufacturing. The components of the eyeglasses 202 can be associated with contributors where each element can be tagged to map out portions of the eyeglasses 202 in the 3D model 106.

The eyeglasses 202 can be disclosed, e.g., advertised, marketed and/or sold publicly (or privately) to permit gathering of social interest or feedback related to one or more aspects of the eyeglasses 202. The image and marketing analysis system 126 can search for images of the eyeglasses 202 on the internet, in periodicals, reviews or other sources. Once the images are discovered, the image and marketing analysis system 126 can review the context of a page or website to determine if particular features are praised or critiqued. In this way, a scoring or ranking of the features of the eyeglasses 202 can be obtained. In an example, social interest can be obtained from on-line sources where reviews, feedback or product evaluations are generated. Social interest can come from social media including but not limited to social websites and platforms. Other sources can also be employed, e.g., internal corporate message boards, emails and other feedback sources. Social interest feedback can be searched for using web crawlers or other searching algorithms, which can search product specifications, product titles, or other information related to the product of interest (e.g., eyeglasses 202 in this example).

The social interest can be fed back as input to the apportionment component 120 and specifically to the NLP 122 which, with the ML algorithm 124, can associate values for the features of the eyeglasses 202 with the contributor's contributions. The NLP 122 and the ML algorithm 124 can use the feedback and associate the feedback with the design elements of the eyeglasses 202. The apportionment component 120 can review product specifications during the evaluation process. This can include the use of similar product models and how elements or components contributed to the success in the market, such as product quality, functionality, and aesthetic appeal.

The contribution aware system 100 can identify functional and non-functional requirements. Non-functional and functional requirements can include the ability to track product model development and project market value, identify individual contributions, and evaluate value based on pre-set criteria. Requirements, product performance, quality, reliability, and user-interface design. These requirements can be aligned with specifications of end-users'needs (freelancers, agencies) with the overall goal of providing credit and compensation based on specific contributions of the contributors to the design of the eyeglasses 202.

The credit distribution system 130 can establish credit and/or compensation metrics. This can include creating detailed criteria to evaluate the value of different contributions and contributor types (e.g., different roles, such as industrial designer, mechanical designer, copyrightable designs, non-copyrightable designs, etc.). The credit distribution system 130 can employ a number of considerations in determining value. For example, elements such as the difficulty level of the 3D modeling task, the time spent on designing, the novelty of the design, the impact of the contribution on the final product, performance characteristics, industry standards, etc. The credit distribution system 130 can be programmed based on input from industry experts, corporate agreements, agreements between contributors, historical patterns, etc. The credit distribution system 130 can be programmed with criteria in an iterative process to refine and perfect the metrics.

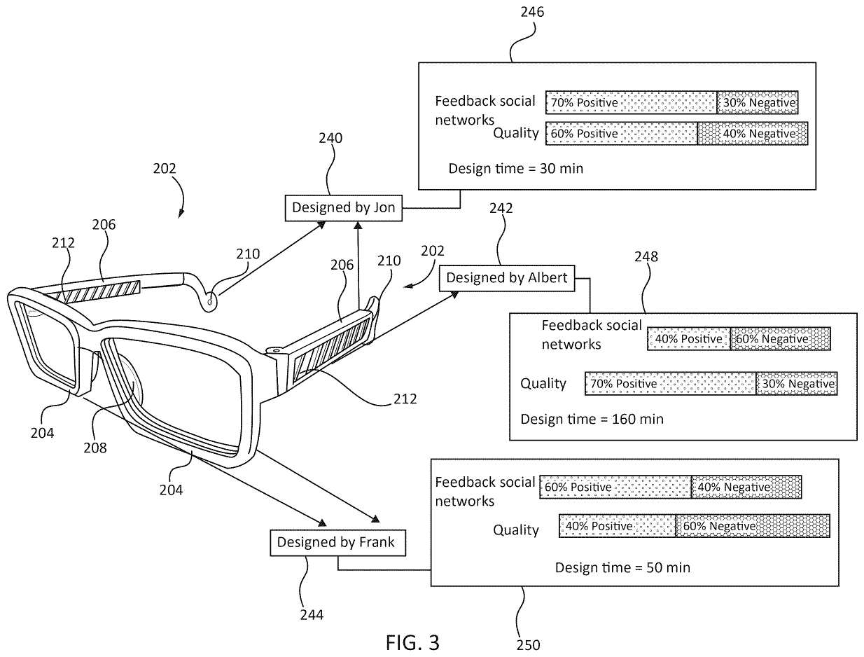

Referring to FIG. 3 with continued reference to FIG. 1, the eyeglasses 202 are illustratively shown with an exemplary output in accordance with an embodiment. The contribution aware system 100 can output contributions 240, 242, 244 of individual users (e.g., Jon, Albert and Frank). Based on the analysis of the apportionment component 120, the image and marketing analysis system 126 and the credit distribution system 130, key features of the eyeglasses 202 are identified that contributed to product success or product fame. Each contributor (e.g., Jon, Albert and Frank) can receive credit for their contributions 240, 242 and 244 based on accumulated criteria and analysis as depicted in blocks 246, 248 and 250. In an embodiment, blocks 246, 248 and 250 employ value criteria, e.g., feedback from social networks, product quality and design time to determine a value or the contributions 240, 242, 244 or the contributors (Jon, Albert and Frank). The value criteria in blocks 246, 248 and 250 can be a distillation of large amounts or collected and analyzed data. The value criteria can be combined to provide credits, a percentage or other measure of value to each contributor. In the example, the feedback social networks and quality are represented as a percentage of positive and negative review results while the design time is represented by units of time. The value criteria can be synthesized, e.g., by machine learning to combine data from a number of sources as a single representation (e.g., a percentage, number, etc.).

The credit distribution system 130 can include tools for recognizing the contributors. In an embodiment, compensation can be distributed to the contributors in accordance with the value added. Other tools of the credit distribution system 130 can include money distribution, which can further include currency conversion, taxation compliance and other agreed upon financial distribution tools.

The credit distribution system 130 can include a robust and secure system for distributing compensation. The credit distribution system 130 can support different payment methods, e.g., bank transfers, e-wallets, etc. and can comply with global financial regulations. If needed, the credit distribution system 130 is capable of handling currency conversion and taxation computations and withholding.

Referring again to FIG. 1, the apportionment component 120 can include the NLP 122 and ML algorithm 124. In accordance with an embodiment, the NLP 122 includes an NLP algorithm that can be trained using a large and diverse dataset of social media and market performance feedback. The NLP 122 and ML algorithm 124 can provide a model, which can be continuously refined until satisfactory performance is achieved and/or to improve the model over time. The NLP 122 can handle ambiguities in natural language, contextual differences and decipher related and/or pertinent information. The apportionment component 120 accurately identifies and assigns credit to contributors based on social interest feedback related to successful product features.

The image and marketing analysis system 126 can also employ machine learning and data analytics to identify successful design elements in the media. This can involve techniques such as, e.g., image recognition to identify patterns and trends in successful designs or statistical analysis to understand correlations between design elements and product success. Publicly available sales data positive reviews, a high number of views on a video platform, etc. can all be employed as input to a ML model.

NLP 122 can include algorithms to extract information from user comments and analysis reports to identify specific features that resonate with customers, such as comfort, quality, popularity, ease of use, etc. and then reward contributors associated with high performing product features.

NLP 122 can include a neural network. The neural network can include a system that improves its functioning and accuracy through exposure to additional empirical data. Input information can include, e.g., 3D model design and development data, social media feedback, product specifications, product design elements, etc. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples, can be formatted as a string of values and fed into the input of the neural network. Each example may be associated with a known result or output. Examples can include contributions of individual contributors or users, key features that contributed to product success, compensation distributions for contributors, etc. Each example can be represented as a pair, (x, y), where x represents the input data and y represents the known output. The input data may include a variety of different data types and may include multiple distinct values. The neural network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, a trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer of source nodes, and a single computation layer having one or more computation nodes that also act as output nodes, where there is a single computation node for each possible category into which the input example could be classified. An input layer can have a number of source nodes equal to the number of data values in the input data. The data values in the input data can be represented as a column vector. Each computation node in the computation layer generates a linear combination of weighted values from the input data fed into nodes of the input layer and applies a non-linear activation function that is differentiable to the sum. The exemplary simple neural network can perform classification on linearly separable examples (e.g., patterns).

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

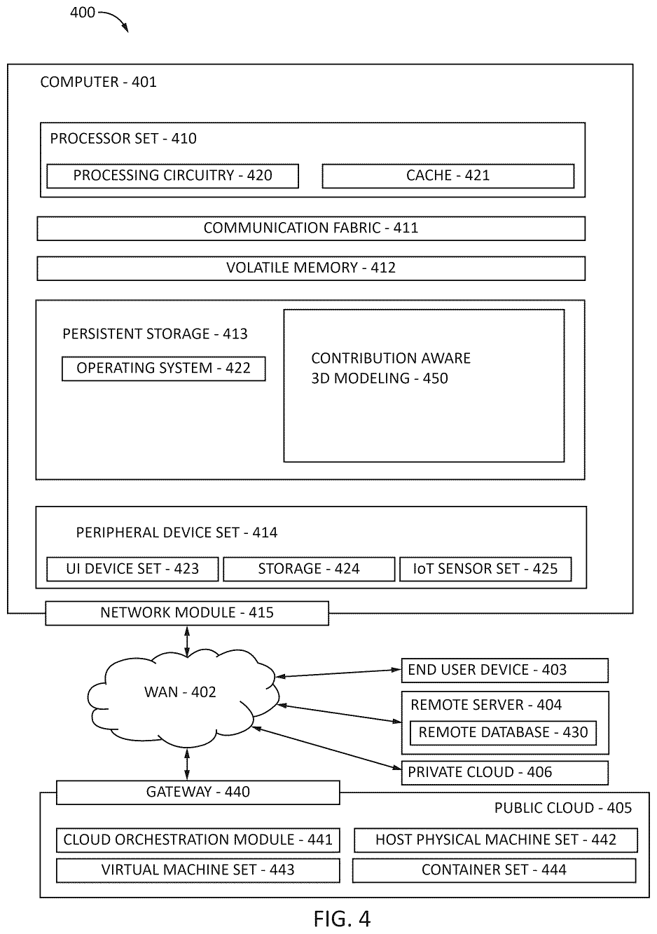

Referring to FIG. 4, a computing environment 400 contains an example of an environment for the execution of at least some of the computer code involved in performing the inventive methods, such as contribution aware 3D modeling 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

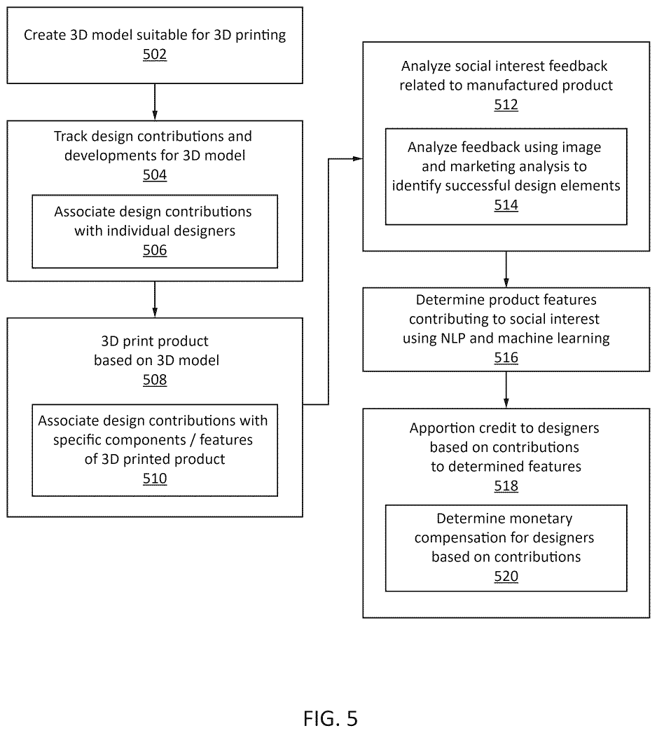

Referring to FIG. 5, a system/computer-implemented method for contribution aware 3D modeling in accordance with embodiments of the present invention is shown and described. In block 502, a 3D model is created. The 3D model can be suitable for 3D printing. In block 504, design contributions and design developments are tracked (e.g., by a tracking component) for the 3D model. In block 506, the design contributions are associated with individual designers by the tracking component.

In block 508, the product can be 3D printed based on the 3D model. In block 510, the tracking component can associate design contributions with specific components or features of the 3D printed product.

In block 512, social interest feedback related to a product manufactured based on the 3D model is analyzed by an apportionment component. The social interest feedback can include product reviews, social media comments, sales data related to the product and any other useful data source. In block 514, the social interest feedback can be analyzed using an image and marketing analysis system to identify design elements that contributed to a success of the product.

In block 516, the apportionment component determines, using natural language processing and machine learning, features of the product that contributed to the social interest. In block 518, apportioning credit, by a credit distribution system, to the individual designers based on their design contributions associated with the determined features.

In block 520, apportioning credit can include determining a monetary compensation for each individual designer based on their design contributions. The credit distribution system can handle financial transactions, such as, currency conversion and royalty calculations for the monetary compensation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
tracking, by a tracking component, design contributions and design developments for a three-dimensional (3D) model;
associating, by the tracking component, the design contributions with individual designers;
analyzing, by an apportionment component, social interest feedback related to a product manufactured based on the 3D model;
determining, by the apportionment component using natural language processing and machine learning, features of the product that contributed to the social interest feedback; and
apportioning, by a credit distribution system, credit to the individual designers based on their design contributions associated with the features.

2. The computer-implemented method of claim 1, wherein the social interest feedback includes product reviews, social media comments, and sales data related to the product.

3. The computer-implemented method of claim 1, wherein analyzing the social interest feedback includes using an image and marketing analysis system to identify design elements that contributed to a success of the product.

4. The computer-implemented method of claim 1, wherein apportioning credit includes determining a monetary compensation for each individual designer based on their design contributions.

5. The computer-implemented method of claim 4, wherein the credit distribution system handles currency conversion and royalty calculations for the monetary compensation.

6. The computer-implemented method of claim 1, further comprising: 3D printing the product based on the 3D model.

7. The computer-implemented method of claim 6, wherein the tracking component associates design contributions with specific components or features of a 3D printed product.

8. A system, comprising:
a processor set;
one or more computer-readable storage media; and
program instructions stored on the one or more computer-readable storage media to cause the processor set to perform operations comprising:
tracking design contributions and design developments for a three-dimensional (3D) model;
associating the design contributions with individual designers;
analyzing social interest feedback related to a product manufactured based on the 3D model;
determining, using natural language processing and machine learning, features of the product that contributed to the social interest feedback; and
apportioning credit to the individual designers based on their design contributions associated with the features.

9. The system of claim 8, wherein the social interest feedback includes product reviews, social media comments, and sales data related to the product.

10. The system of claim 8, wherein analyzing the social interest feedback includes using an image and marketing analysis system to identify design elements that contributed to a success the product.

11. The system of claim 8, wherein apportioning credit includes determining a monetary compensation for each individual designer based on their design contributions.

12. The system of claim 8, wherein a credit distribution system handles currency conversion and royalty calculations for monetary compensation.

13. The system of claim 8, further comprising program instructions to cause the processor set to perform operations comprising:
3D printing the product based on the 3D model.

14. The system of claim 13, wherein a tracking component associates design contributions with specific components or features of the product.

15. A computer program product, comprising:
one or more computer-readable storage media; and
program instructions stored on the one or more computer-readable storage media to perform operations comprising:
tracking design contributions and design developments for a three-dimensional (3D) model;
associating the design contributions with individual designers;
analyzing social interest feedback related to a product manufactured based on the 3D model;
determining, using natural language processing and machine learning, features of the product that contributed to the social interest feedback; and
apportioning credit to the individual designers based on their design contributions associated with the features.

16. The computer program product of claim 15, wherein the social interest feedback includes product reviews, social media comments, and sales data related to the product.

17. The computer program product of claim 15, wherein analyzing the social interest feedback includes using an image and marketing analysis system to identify design elements that contributed to a success of the product.

18. The computer program product of claim 15, wherein apportioning credit includes determining a monetary compensation for each individual designer based on their design contributions.

19. The computer program product of claim 18, wherein the operations further comprise handling currency conversion and royalty calculations for the monetary compensation.

20. The computer program product of claim 15, wherein the operations further comprise:
3D printing the product based on the 3D model; and
associating design contributions with specific components or features of the product.
